(19) United States
(12) Patent Application Publication
(10) Pub. No.: US 2012/0053985 A1
(43) Pub. Date: Mar. 1, 2012

(54) MULTI-CUSTOMER UNIT CAPITAL COST DETERMINATION SYSTEM

(75) Inventor: Anthony Tillman, Willingboro, NJ (US)

(73) Assignee: Verizon Patent and Licensing Inc., Basking Ridge, NJ (US)

(21) Appl. No.: 12/870,119

(22) Filed: Aug. 27, 2010

(51) Int. Cl. G06Q 10/00

(52) U.S. Cl. 705/7.29; 705/400

(57) ABSTRACT

A computing-device implemented method for generating cost to connect information associated with multi-customer premises may include receiving, from a productivity tracking system, labor time information associated with a number of service installation orders, wherein the labor time information includes a multi-customer premises indicator. Material information relating to multi-customer premises may be received from an inventory tracking system. Cost to connect information may be automatically calculated based on the labor time information and the material information.

### BACKGROUND

Accurately accounting for costs associated with provisioning equipment and services in modern wide scale commercial networks is useful in enabling the network installer or service provider to efficiently manage workflow requirements and establish price points. Unfortunately, given the variety in installation and service environments and the similarities between equipment and services provided in the different environments, it can be problematic to differentiate between different types of environments.

### BRIEF DESCRIPTION OF THE DRAWINGS

FIG. 1 illustrates a block diagram of an exemplary environment in which systems and methods described herein may be implemented;

FIG. 2 is a diagram illustrating exemplary components of the service provider of FIG. 1;

FIGS. 3-6 are functional block diagrams of exemplary components implemented in the service provider systems of FIG. 1; and

FIGS. 7 and 8 are flow diagrams illustrating exemplary processing associated with generating cost to connect metric information consistent with embodiments described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the embodiments disclosed herein.

Consistent with the following description, devices, methods, and systems are provided for calculating and presenting multi-customer premises cost to connect calculations and metric information. As discussed above, differentiating between similar equipment and service provisions in different types of service environments can be difficult. For example, some types of multi-customer service locations may be provisioned with identical or substantially identical equipment and services, thereby rendering cost calculation information for each type of location difficult to accurately obtain.

As described below, in one exemplary implementation, premises information and equipment may be associated with a unit type indicator that indicates the type of premise associated with the location or equipment. The unit type indicator may be forwarded across multiple inventory, service provisioning, and workflow systems and associated with data collected during the provisioning of service or equipment to particular premises. Workflow (e.g., labor hours) and inventory (e.g., equipment and materials) information associated with the unit type indicator may be compiled to generate accurate and comprehensive cost to connect metric information.

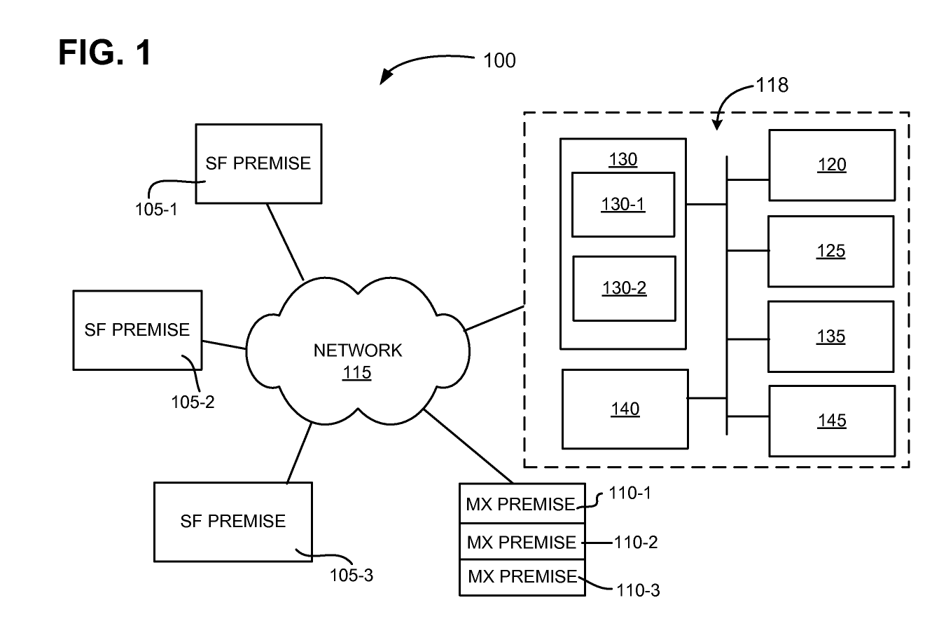

FIG. 1 is a block diagram of an exemplary environment 100 in which systems and methods described herein may be implemented. As shown, environment 100 may include a number of customer premises locations including single family (SF) premises 105-1, 105-2, and 105-3 (collectively “SF premises 105” and individually “SF premise 105”), and multi-customer (MX) premises 110-1, 110-2, and 110-3 (collectively “MX premises 110” and individually “MX premise 110”) connected to a network 115, either directly, or indirectly. As described herein, SF premises 105 may include any customer location connected to network 115 via an external (e.g., box mounted, pole mounted, etc.) fiber terminal. In contrast, MX premises 110 may include any customer location connected to network 115 via a premise-located fiber distribution terminal (FDT) or a multi-customer (MC) network terminal, such as a MC optical network terminal (ONT). For MX premises 110, multiple customers may be service via a single FDT or MC ONT. In some embodiments, MC ONT's may be referred to as multi-dwelling unit (MDU) ONT's or multi-tenant unit (MTU) ONT's.

In some instances, both SF premises 105 and MC premises 110 may be connected via SF ONTs, such as when a multi-customer unit is coupled to network 115 via an internal FDT. As described above, the use of similar equipment in both SF premises 105 and MX premises 110 makes it difficult to independently account for the costs associated with each type of installation. Consistent with implementations described herein, environment 100 enables the accurate and efficient calculation of such differentiated cost metrics.

As shown in FIG. 1, in addition to premises 105/110 and network 115, environment 100 also includes a number of service provider systems 118 for provisioning, providing, maintaining, and servicing network 115 and equipment at premises 105/110. For example, as shown in FIG. 1, environment 100 may include a facility engineering and accounting system 120, a service provisioning system 125, a technician dispatch tool system 130, a workforce productivity management system 135, a capital management system 140, and a video service office (VSO) 145 connected to each other, either directly or indirectly, via network 115. In some implementations, systems 120-145 may be connected via a network different than (or in addition to) network 115, such as a corporate network, etc.

Facility engineering and accounting system 120 may include one or more databases, processors, and/or software applications configured to provide information regarding network 115 for use by service provider systems 118. For example, facility engineering and accounting system 120 may maintain and provide materials, maintenance, and accounting information relating to equipment and cabling within environment 100. The information contained in facility engineering and accounting system 120 enables network engineers to accurately determine the location, characteristics and components of the outside plant (OP) components in environment 100. As used herein, the term “outside plant” refers to equipment located outside of the service provider's facilities (e.g., outside of VSO 145, etc.). An exemplary facility engineering and accounting system 120 includes Verizon's intelligent computer graphics system (ICGS) and/or other inventory and accounting systems.

Service provisioning system 125 may include one or more engineering, operation, and inventory databases and systems that maintain and provide information relating to activating and provisioning service orders in environment 100. Service provisioning system 125 may include tools for enabling entry and tracking of customer premises service orders and may actively transmit information regarding the orders to other systems in environment 100, such as technician dispatch tool system 130. In some implementations service provisioning system 125 may include inventory information associated with all devices and equipment within environment 100, including cabling, wiring, network devices, etc. One exemplary service provisioning system 125 includes iVAPP (integrated Verizon Advanced Provisioning Platform).

Technician dispatch tool system 130 may include a number of portable devices (e.g., 130-1, 130-2, also referred to as mobile dispatch devices 130-x) that enable service technicians to dispatch work assignments. For example, in one embodiment, technician dispatch tool system 130 may include a handheld or mobile computing device for providing service locations and job details to technicians. As described in additional detail below, mobile dispatch devices 130-x may provide an interface for enabling technicians to enter and submit information relating to labor time and/or material expenditures expended in dispatching work assignments. For example, service orders in technician dispatch tool system 130 may be broken down into tasks, each requiring data entry by a technician. Technician dispatch tool system 130 may receive work order information from service provisioning system 125, via network 115. One exemplary technician dispatch tool system includes Verizon's vMobile tool system.

Workforce productivity management system 135 may include one or more databases, processors, and/or software applications configured to enable the tracking and management of employee productivity. In one implementation, workforce productivity management system 135 may receive information from technician dispatch tool system 130 (e.g., via network 115) relating to performance of tasks associated with service orders and other work assignments. As described in detail below, workforce productivity management system 135 may be allow evaluators to generate a number of cost metrics and/or metric-related reports relating to installation and service activities. For example, evaluators may use the information collected by workforce productivity management system 135 to generate one or more “cost to connect” metrics associated with provisioning service to premises 105/110. An exemplary workforce productivity management system includes Verizon's service assurance business intelligence toolkit (SABIT).

Capital management system 140 may include one or more computing devices, servers, software systems, and/or backend systems that are able to connect to network 115 and retrieve information from systems 120-135 relating to costs and expenditures associated with provisioning customers in environment 100. As described below, capital management system 140 may receive information from one or more of systems 120-135 and calculate accurate cost metric data relating to the total cost of provisioning service to, for example, MX premises 110.

VSO 145 may include one or more computing devices, servers and/or backend systems that are able to connect to network 115 and transmit and/or receive information via network 115. In one implementation, VSO 145 may include a server (e.g., a computer system or an application), a cable head-end, or a broadcaster capable of providing content (e.g., TV programming, movies, on-demand services, live television, news feeds, blog feeds, widgets, applications, etc.), advertisements, instructions, codes, encryption keys, and/or other information associated with products and/or services, etc., to one or more devices located at premises 105/110.

Network 115 may include one or more wired, wireless and/or optical (e.g., fiber optic) networks that are capable of receiving and transmitting data, voice and/or video signals, including multi-media signals that include voice, data and video information. For example, network 115 may include one or more public switched telephone networks (PSTNs) or other type of switched network. Network 115 may also include one or more wireless networks and may include a number of transmission towers for receiving wireless signals and forwarding the wireless signals toward the intended destinations. Network 115 may further include one or more satellite networks, one or more packet switched networks, such as an Internet protocol (IP) based network, a local area network (LAN), a wide area network (WAN), a personal area network (PAN) (e.g., a wireless PAN), an intranet, the Internet, or another type of network that is capable of transmitting data.

Consistent with implementations described herein, to provision equipment and services to a premise 105 or 110, facility engineering and accounting system 120 may receive and store information relating to the type of installation required for the premises in addition to other equipment relating to an OP in environment 100. In addition, facility engineering and accounting system 120 may maintain inventory information relating to provisioned or to-be provisioned equipment in environment 100. For example, facility engineering and accounting system 120 may maintain a database of installed materials/equipment for premises 105/110. Consistent with implementations described herein, identifiers associated with the database may allow tracking of direct material/equipment and labor costs for each premise 105/110.

For example, facility engineering and accounting system 120 may store a unit type indicator in a database or other memory structure/device, such as a continuing property records file or complement file. A continuing property records (CPR) file is a database for maintaining data for accounting for OP equipment. A complement file is a database for maintaining data relating to cabling characteristics, such as cable counts, cable complements for OP locations, etc.

The inclusion of this identifier may allow efficient and accurate tracking of the costs associated with provisioning service to different types of environments that use similar equipment. For example, some MX premises 110 are provisioned in a manner substantially similar to SF premises 105 (e.g., using SF ONTs). By including the unit type indicator, a distinction between the premise types may be associated with the equipment identified in facility engineering and accounting system 120.

As described above, service provisioning system 125 may include one or more engineering/operation databases and systems that maintain and provide information relating to activating and provisioning service orders in environment 100. During configuration/data population of service provisioning system 125 with information relating to installation and servicing orders, facility engineering and accounting system 120 may forward or otherwise supply data that includes the unit type indicator (among other elements of information) to service provisioning system 125. In other implementations, service provisioning system 125 may extract or retrieve the information from facility engineering and accounting system 120. In either case, service provisioning system 125 may associate the unit type indicator with each installation or service order. For example, a field in an entry in a database associated with installation and/or service orders may be populated with a value corresponding to the unit type indicator.

During configuration of each mobile dispatch device 130-x in technician dispatch tool system 130 information relating to installation and servicing orders assigned to a particular technician (or team of technicians) may be transmitted to and received by mobile dispatch devices 130-x. For example, at the start of each work day, a technician's mobile dispatch device 130-x may be updated to include work order information from service provisioning system 125 for that day's jobs. In other implementations, work order information may be continually updated via network 115. In either case, information from service provisioning system 125 relating to work orders or job descriptions included in mobile dispatch device 130-x may be configured to include the unit type indicator initially stored by facility engineering and accounting system 120 as part of the OP information.

Consistent with implementations described herein, mobile dispatch devices 130-x and technician dispatch tool system 130 may enable entry, capture, and/or monitoring of technician-related activities and information, such as location information, status information, installation notes, time tracking information, etc. For example, assume that mobile dispatch device 130-1 includes or has been provided with (e.g., from service provisioning system 125), information relating to a work order for installing a MC ONT in MXU 110-1. For this work order, mobile dispatch device 130-1 may be configured to receive technician information relating to the following labor information: copper wire removal time, drop placement time, ONT activation time, removal time, rearrangement time, and fiber cross-connect time.

As briefly described above, workforce productivity management system 135 may be configured to receive, either continually or periodically, information regarding the performance of each technician from technician dispatch tool system 130. For example, mobile dispatch device 130-1 may be configured to transmit the above-described technician labor information, along with the associated unit type indicator to workforce productivity management system 135. In other implementations, the technician labor information may be calculated or otherwise inferred or estimated based on information received from technician dispatch tool system 130.

Capital management system 140 may be configured to receive the tracked labor information from workforce productivity management system 135. Capital management system 140 may be further configured to receive equipment and materials cost information from facility engineering and accounting system 120. For example information regarding direct materials used in the performance of the work order may be received from workforce productivity management system 135. Direct materials may include hardware equipment, etc. Capital management system 140 may be configured to calculate or estimate non-direct (also referred to as exempt material) based on the received direct material information. For example, exempt material information may be calculated as a percentage of the direct material information, or may be based on historical material usage and inventory trends, etc.

In some implementations, additional labor information for MX premises 110 may also be received from facility engineering and accounting system 120. For example, MX premises 110 connected to network 115 via a MC ONT may be tracked independently of workforce productivity management system 135 and provided to capital management system 140 by other systems. Cost metric reports may be generated in capital management system 140 based on the received labor and materials information. In some implementations, the metric reports may provide a detailed description of labor and materials costs associated with provisioning service to MX premises.

The exemplary configuration illustrated in FIG. 1 is provided for simplicity. It should be understood that a typical environment 100 may include more or fewer devices and/or systems than illustrated in FIG. 1. For example, although three SF premises 105, three MX premises 110, one network 115, one facility engineering and accounting system 120, one service provisioning system 125, two mobile dispatch devices 130-x, one workforce productivity management system 135, one capital management system 140, and one VSO 145 have been illustrated in FIG. 1, in practice, there may be more or fewer devices, systems, and/or networks. Network 115 may also include additional elements, such as switches, gateways, routers, backend systems, etc., that aid in routing or delivering information. Also, in some instances, one or more of the components of environment 100 may perform one or more functions described as being performed by another one or more of the components of environment 100.

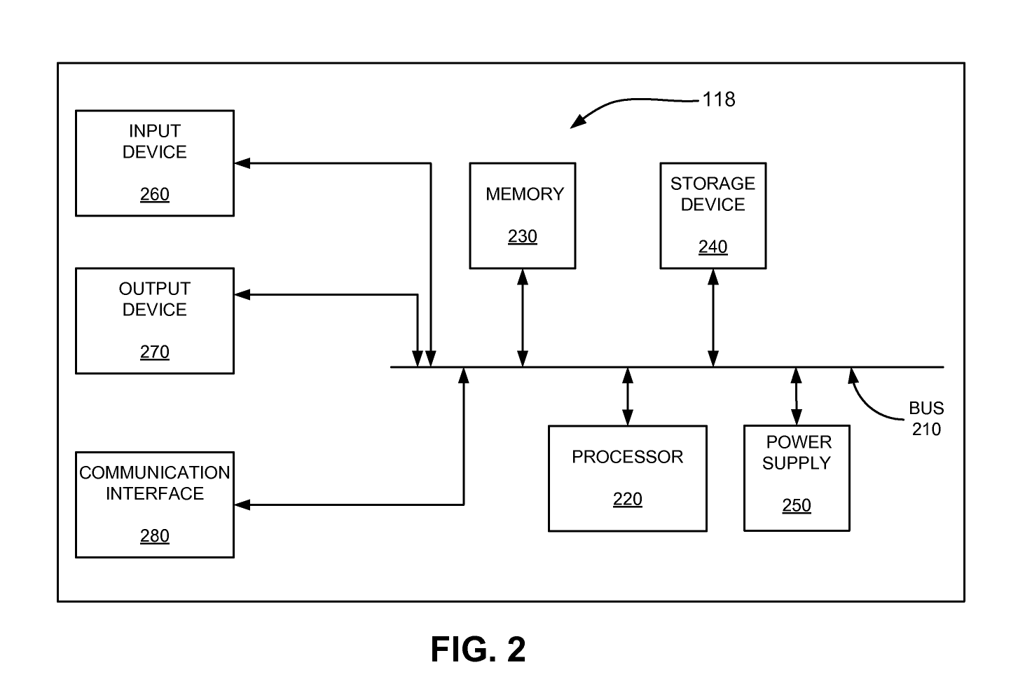

FIG. 2 is a diagram illustrating exemplary components of one or more of systems/devices 120-145 in service provider systems 118. Referring to FIG. 2, service provider systems 118 (e.g., a computer, workstation, server, mobile computing device, database device, file storage device, etc.) may each include a bus 210, processor 220, memory 230, storage device 240, power supply 250, input device 260, output device 270, and communication interface 280. Service provider systems 118 may be configured in a number of additional ways and may include other or different elements. For example, service provider systems 118 may include one or more modulators, demodulators, encoders, decoders, etc., for processing data.

Bus 210 may include a path that permits communication among the elements of service provider systems 118. Processor 220 may include one or more processors, microprocessors, application specific integrated circuits (ASICs), field programmable gate arrays (FPGAs), or other processing logic that may interpret and execute instructions. Memory 230 may include a random access memory (RAM) or another type of dynamic or static (e.g., read only memory (ROM)) storage device that may store information and instructions for execution by processor 220. Storage device 240 may include a magnetic and/or optical recording medium and its corresponding drive. Power supply 250 may include a battery or other power source powering service provider systems 118.

Input device 260 may permit a user to input information to service provider systems 118, such as a microphone, a keypad, a keyboard, a touch screen, a mouse, a pen, etc. Output device 270 may output information to the user, such as a display, a printer, one or more speakers, etc.

Communication interface 280 may include a transceiver that enables service provider systems 118 to communicate with other devices and/or systems, such as systems/tools 120-145. For example, communication interface 280 may include interfaces, such as a modem or Ethernet interface, for communicating via a network, such as customer network 110.

In implementations consistent with embodiments described herein, service provider systems 118 may perform processing associated with receiving, collecting, and disseminating information relating to the costs associated with provisioning service to customer premises, such as SF premises 105 and MX premises 110.

For example, as briefly described above, service provider systems 118 may operate together to generate a cost to connect metric associated with multi-customer premises 110. More specifically, service provider systems 118 may receive unit type identification information that enables cost calculations for MX environments, by recognizing a distinction between SF premises 105 and MX premises 110.

Service provider systems 118 may perform these operations in response to one or more processors 220 executing sequences of instructions contained in a computer-readable medium, such as one or more memories 230. A computer-readable medium may include a physical or logical memory device. The software instructions may be read into memories 230 from another computer-readable medium, such as data storage device 240, or from another device via communication interface 280. The software instructions contained in memories 230 may cause the one or more processor 220 to perform processes that are described below. Alternatively, in some instances, hard-wired circuitry may be used in place of or in combination with software instructions to implement processes consistent with the embodiments described herein. Thus, implementations described herein are not limited to any specific combination of hardware circuitry and software. For the purposes of this application, a “computer” may be defined as a device, or combination of devices, that performs high-speed mathematical or logical operations, or that assembles, stores, correlates, or otherwise processes information.

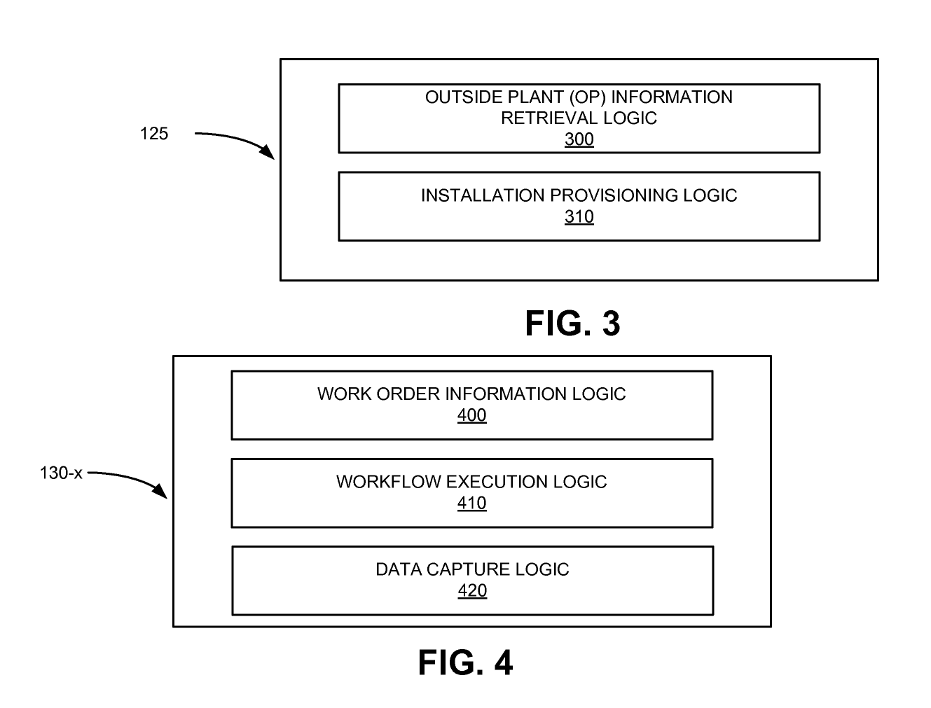

FIG. 3 is a functional block diagram of exemplary components implemented in service provisioning system 125 of FIG. 1. The logical blocks illustrated in FIG. 3 may be implemented in software, hardware, a combination of hardware and software. As shown, service provisioning system 125 may include outside plant (OP) information retrieval logic 300 and installation provisioning logic 310. Various logic components illustrated in FIG. 3 may be implemented by processor 220 executing one or more programs stored in memory 230. In some implementations, one or more components of FIG. 3 may be implemented in other devices associated with service provider systems 118. Furthermore, service provisioning system 125 may include a single executable application or may include more than one executable application.

In one implementation, OP information retrieval logic 300 may include logic configured to receive or retrieve information from facility engineering and accounting system 120. As described above, the retrieved information may include information relating to locations, equipment, wiring, and inventory associated with the OP. In addition, in some implementations, OP information retrieval logic 300 may retrieve the unit type indicator identifier from facility engineering and accounting system 120 indicating a type of premise associated with a location, address, etc. OP information retrieval logic 300 may store the received information into a database or other structure (e.g., in memory 230 and/or storage device 240).

Installation provisioning logic 310 may include logic configured to establish service provisioning orders based on received information. In some implementations, installation provisioning logic 310 may include an order entry system for receiving customer service requests. In some implementations, installation requests may include construction-related requests for pre-service equipment and labor. In response to the requests, installation provisioning logic 310 may be configured to identify OP information associated with the service location (e.g., address), such as the unit type indicator, OP equipment associated with the location (e.g., a proximate fiber terminal identifier, etc.), applicable jurisdiction, etc.

Installation provisioning logic 310 may be further configured to transmit (via network 115) service order information to technician dispatch tool system 130 for eventual transmission to a mobile dispatch device 130-x associated with an appropriate installation technician. For example, installation provisioning logic 310 may periodically transmit configured service order information to technician dispatch tool system 130 for execution/action.

FIG. 4 is a functional block diagram of exemplary components implemented in mobile dispatch devices 130-x. The logical blocks illustrated in FIG. 4 may be implemented in software, hardware, a combination of hardware and software. As shown, mobile dispatch devices 130-x may include work order information logic 400, workflow execution logic 410, and data capture logic 420. Various logic components illustrated in FIG. 4 may be implemented by processor 220 executing one or more programs stored in memory 230. In some implementations, one or more components of FIG. 4 may be implemented in other devices associated with service provider systems 118, such as a web-based information portal. Furthermore, mobile dispatch devices 130-x may include a single executable application or may include more than one executable application.

Work order information logic 400 may include logic configured to receive work order information from service provisioning system 125. In one implementation, one or more control devices in technician dispatch tool system 130 (e.g., an assignment server, administration device, etc.) may be configured to periodically receive work order information from installation provisioning logic 310 in service provisioning system 125. The control device may be identify appropriate and/or available technicians and may assign the work order to the identified technician. The work order information may be transmitted to work order information logic 400 in the mobile dispatch device 130-x associated with the assigned technician.

As described above, the received work order information may include location information, task information, and, consistent with implementations described herein, the unit type indicator associated with the work order location or address.

Workflow execution logic 410 may include logic configured to display work order information to a technician in a manner that enables the technician to efficiently prepare for and perform the necessary tasks identified in the received work order information. For example, workflow execution logic 410 may include interface logic for graphically providing work order information to the technician, such as location information associated with the job, job description information, time estimate information for the tasks associated with the work order, etc.

Data capture logic 420 may include logic configured to operate with workflow execution logic 410 to receive or capture information relating to the performance of the tasks associated with the work order. For example, data capture logic may capture time-tracking information (either directly by the technician or via an integrated timing mechanism) for the tasks. In addition, data capture logic 420 may capture geographic location information associated with the mobile dispatch devices 130-x during execution of the tasks. In some embodiments, data capture logic 420 may receive material and equipment usage information, such as an amount of wire or cable used, etc. In any event, the data collected by data capture logic 420 may provide an accurate accounting of labor needed to perform the work order tasks.

In some implementations, data capture logic 420 may be configured to query technicians regarding particular information relating to the work order or execution of the work order tasks. For example, data capture logic 420 may query the technician about the type of environment associated with the work order (e.g., a SF premises 105 or a MX premises 110), such as via a drop-down menu in a user interface, a check box selection, etc. In such an implementation, responses to this query may be associated with the captured work order information and may be forwarded to capital management system 140 for use in determining cost to connect metric information.

In some implementations, work order information logic 400 may be configured to transmit the captured work order task completion data back to the control device or server associated with technician dispatch tool system 130. In this manner, data from a number of mobile dispatch devices 130-x may be collected and used to facilitate review and analysis of the resources required to perform the tasks identified in work orders and to determine whether estimates regarding the resources are sufficiently accurate.

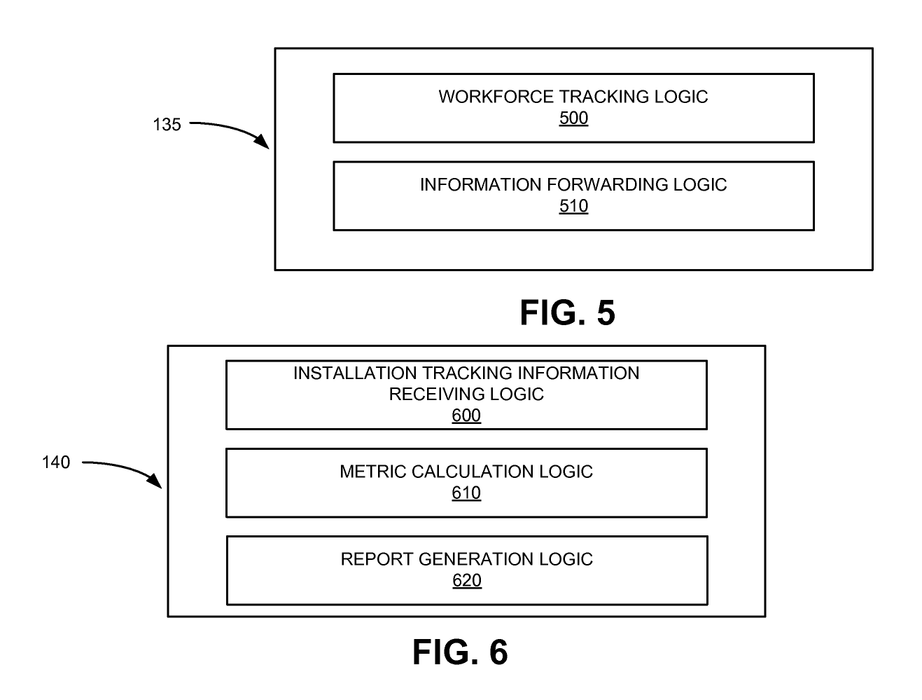

FIG. 5 is a functional block diagram of exemplary components implemented in workforce productivity management system 135. The logical blocks illustrated in FIG. 5 may be implemented in software, hardware, a combination of hardware and software. As shown, workforce productivity management system 135 may include workforce tracking logic 500 and information forwarding logic 510. Various logic components illustrated in FIG. 5 may be implemented by processor 220 executing one or more programs stored in memory 230. In some implementations, one or more components of FIG. 5 may be implemented in other devices associated with service provider systems 118. Furthermore, workforce productivity management system 135 may include a single executable application or may include more than one executable application.

Workforce tracking logic 500 may include logic configured to receive work order task completion data from technician dispatch tool system 130. For example, each of technician dispatch tool system 130 and workforce productivity management system 135 may be connected via network 115. Workforce tracking logic 500 may be further configured to compile work order task completion information for a number of mobile technician dispatch devices 130-x to form productivity and/or workflow reports, time/material expenditure reports, etc. In some implementations, these metrics and reports may be automatically generated on a periodic basis. In other instances, workforce tracking logic 500 may provide a user interface that enables system users to affirmatively request the generation of a particular report or metric. In still other instances, compiled information and/or metrics may be stored in workforce productivity management system 135 (e.g., in a database or other data structure in storage device 240).

Information forwarding logic 510 may include logic configured to forward information relating to compiled work order information to requesting devices or systems, such as capital management system 140. In one implementation, information forwarding logic 510 may be configured to automatically forward defined elements, reports, or metrics based on the collected work order data to identified devices (e.g., server addresses, Internet protocol addresses, email addresses, etc.).

In other implementations, information forwarding logic 510 may be configured to provide a search interface for allowing devices, such as capital management system 140, to identify, request, and retrieve particular elements or metrics in the compiled work order data. Consistent with implementations described herein, information forwarding logic 510 may be configured to periodically (or upon request) transmit information to capital management system 140 based on a particular unit type identifier value or particular responses to technician unit type queries associated with MX premises 110. As described above in relation to FIG. 1, the forwarded information may include time-tracking information for various tasks associated with each work order, material information, expense information, etc.

FIG. 6 is a functional block diagram of exemplary components implemented in capital management system 140. The logical blocks illustrated in FIG. 6 may be implemented in software, hardware, a combination of hardware and software. As shown, capital management system 140 may include installation tracking information receiving logic 600, metric calculation logic 610, and report generation logic 620. Various logic components illustrated in FIG. 6 may be implemented by processor 220 executing one or more programs stored in memory 230. In some implementations, one or more components of FIG. 6 may be implemented in other devices associated with service provider systems 118. Furthermore, capital management system 140 may include a single executable application or may include more than one executable application.

Installation tracking information receiving logic 600 may include logic configured to receive and store information relating to time and materials used to install and provision equipment and services in environment 100. Consistent with implementations described herein, such information may include MC ONT-specific information. In addition, installation tracking information receiving logic 600 may receive information associated with MX premises unit type identifiers from workforce tracking logic 500. In other implementations, as discussed above, installation tracking information receiving logic 600 may be configured to receive work order information associated with particular technician query responses.

In still other implementations, installation tracking information receiving logic 600 may be configured to receive all captured information from workforce tracking logic 500. In this implementation, capital management system 140 may be configured to interrogate and analyze the data in its entirety to extract relevant and useful information therefrom.

Metric calculation logic 610 may include logic configured to retrieve the received work order information and calculate therefrom metric information associated with the cost to connect MX premises 110. For example, metric calculation logic 610 may compile information for all MX premises information received within a particular time period and generate an average cost to connect. In some instances, the cost to connect metric information may be calculated for each of a number of jurisdictions or regions (e.g., states, counties, geographic regions, etc.). Furthermore, the cost to connect metric information may be broken down into constituent cost elements, such as labor costs, expense costs, and material costs. In some embodiments, the cost to connect metric information may be calculated at least partially automatically, upon receipt of the information.

Report generation logic 620 may be configured to generate one or more reports based on the calculated metric information. For example, report generation logic 620 may generate cost to connect reports based on location or “turf,” premise type, installation type, labor hours data, etc.

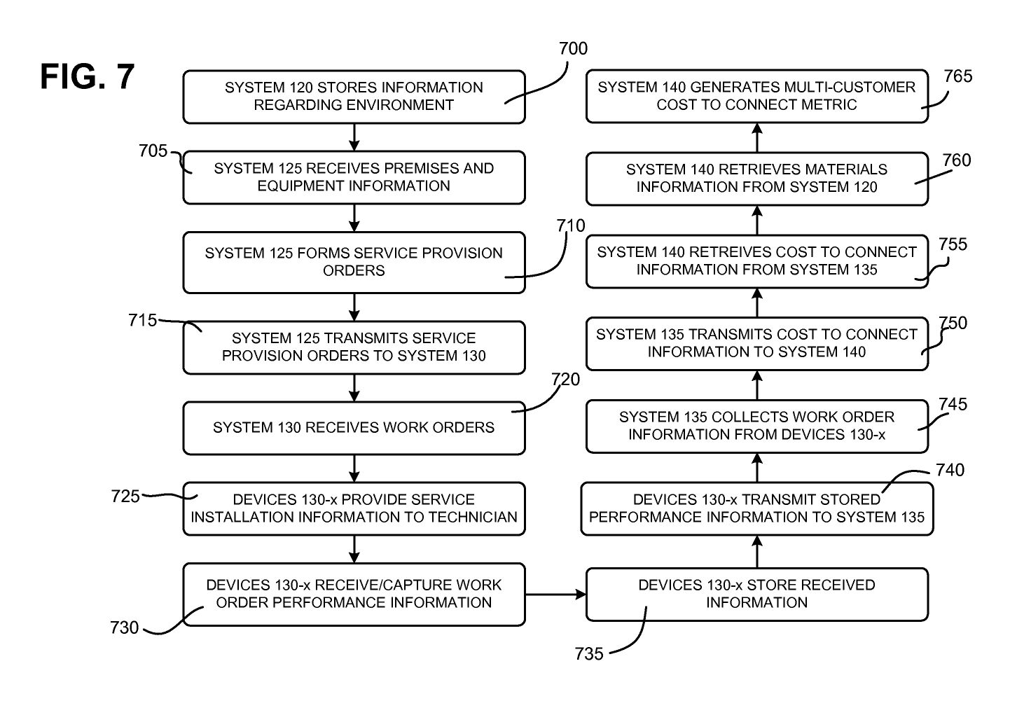

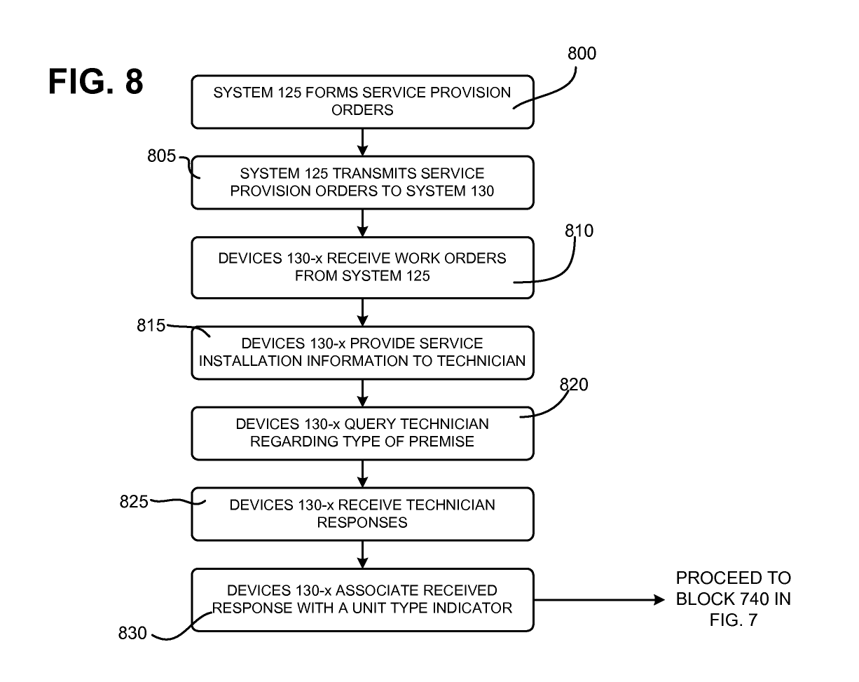

FIG. 7 is a flow diagram illustrating exemplary processing associated with generating cost to connect metric information in an embodiment described herein. Processing may begin with facility engineering and accounting system 120 receiving and storing information regarding environment 100 (block 700). As described above, facility engineering and accounting system 120 may collect, maintain and provide materials, maintenance, and accounting information relating to equipment and cabling within environment 100. Consistent with embodiments described herein, the received and stored information may include a unit type indicator for each premise 105/110 in environment 100. The unit type indicator indicates whether each premise 105/110 is a SF premise 105 or a MX premise 110.

Service provisioning system 125 may receive/retrieve premises and equipment information from facility engineering and accounting system 120 (block 705). As described above, for each premise 105/110, the received information may include the unit type indicator. Service provisioning system 125 may form service provision orders based on, for example, an interface with an order entry system (block 710). The service provision orders may include the unit type indicator for the associated premise 105/110 received from facility engineering and accounting system 120.

Service provisioning system 125 may transmit or forward service orders to technician dispatch tool system 130 (block 715). For example, service provisioning system 125 may be configured to periodically (e.g., daily, hourly, upon order creation, hourly, etc.) transmit generated service orders to technician dispatch tool system 130 for scheduling and assignment/dissemination to appropriate technicians. The service provision orders may include the unit type indicator for the associated premise 105/110 received from facility engineering and accounting system 120.

A mobile dispatch device 130-x may receive one or more service installation orders (also referred to as “work orders” herein) (block 720). For example, a technician dispatch tool system 130 control device (e.g., server, etc.) may identify and forward pending service installation orders to a mobile dispatch device 130-x associated with an appropriate technician. In other implementations, the scheduling/assignment of work orders to technicians' mobile dispatch devices 130-x may be performed by service provisioning system 125.

Mobile dispatch device 130-x may provide service installation information regarding the service/work order to the technician(s) associated therewith (block 725). For example, output device 270 of mobile dispatch device 130-x may provide a graphical interface for providing information relating to pending work orders. Mobile dispatch device 130-x may receive or capture technician-related information relating to the performance or execution of the work order (block 730). For example, mobile dispatch device 130-x may receive time-tracking information, equipment information, installation notes, geographic location information, etc.

Mobile dispatch device 130-x may store the received information (e.g., in storage device 240) and associate the stored information with the unit type indicator for the associated premise 105/110 (block 735). In this manner, a positive indication is stored relating to the type of premise 105/110 associated with the work performed. Collectively, the stored information may be referred to as work order status/completion information and it may provide a record of the technician related activities.

Mobile dispatch device 130-x may transmit or otherwise forward the stored work order status/completion information to workforce productivity management system 135 (block 740). For example, mobile dispatch device 130-x may be configured to automatically or periodically forward the stored work order status/completion information to workforce productivity management system 135 via network 115 upon entry/capture. In other implementations, the work order status/completion information may be initially transmitted to a technician dispatch tool system 130 control device.

Workforce productivity management system 135 may collect work order status/completion information for a number of mobile dispatch devices 130-x (block 745) and compile the information into workforce performance/productivity metric information. Workforce productivity management system 135 may transmit cost to connect information to capital management system 140 (block 750). For example, workforce productivity management system 140 may be configured to extract cost-related information from the received work order status/completion information. Exemplary cost-related information may include time-tracking information for particular tasks, equipment costs, etc. Consistent with implementations described herein, the cost to connect information may include premises location information (e.g., geographic information) and the unit type indicator for each associated premise 105/110. In some implementations, the cost to connect information may provided as one or more reports broken down by premise type, geographic location, etc.

Capital management system 140 may retrieve the cost to connect information from workforce productivity management system 135 (block 755). Capital management system 140 may also retrieve equipment and materials information from facility engineering and accounting system 120 (block 760). In addition, in some implementations, capital management system 140 may be configured to receive MC ONT related cost to connect information from one or more MC ONT-related systems.

Capital management system 140 may generate multi-customer cost to connect metric and reporting information based on the information retrieved/received from workforce productivity management system 135, and facility engineering and accounting system 120 (block 765). For example, metric calculation logic 610 may include logic configured to retrieve the received work order information and calculate therefrom metric information associated with the cost to connect MX premises 110. For example, metric calculation logic 610 may compile (or may facilitate the compilation of) information for all MX premises information received within a particular time period and generate an average cost to connect. As described above, report generation logic 620 may generate and output one or more reports based on the calculated cost to connect metric information.

FIG. 8 is a flow diagram illustrating exemplary processing associated with generating cost to connect metric information consistent with another embodiment. Processing may begin with service provisioning system 125 forming service provision orders based on, for example, an interface with an order entry system (block 800). Service provisioning system 125 may transmit or forward service orders to technician dispatch tool system 130 (block 805). For example, as described above, service provisioning system 125 may be configured to periodically (e.g., daily, hourly, upon order creation, hourly, etc.) transmit generated service orders to technician dispatch tool system 130 for scheduling and assignment/dissemination to appropriate technicians.

A mobile dispatch device 130-x may receive one or more work orders from service provisioning system 125 (block 810). For example, a technician dispatch tool system 130 control device (e.g., server, etc.) may identify and forward pending service installation orders to a mobile dispatch device 130-x associated with an appropriate technician. In other implementations, the scheduling/assignment of work orders to technicians' mobile dispatch devices 130-x may be performed by service provisioning system 125.

Mobile dispatch device 130-x may provide service installation information regarding the service/work order to the technician(s) associated therewith (block 815). For example, output device 270 of mobile dispatch device 130-x may provide a graphical interface for providing information relating to pending work orders. Mobile dispatch device 130-x may query the technician regarding the type of premise 105/110 associated with the work order (block 820). For example, mobile dispatch device 130-x may query the technician about the type of environment associated with the work order via a drop-down menu in a user interface, a check box selection, etc.

Mobile dispatch device 130-x may receive or capture technician-related information relating to the performance or execution of the work order (block 825). For example, mobile dispatch device 130-x may receive time-tracking information, installation notes, geographic location information, etc. Mobile dispatch device 130-x may store the received information (e.g., in storage device 240) and associate the stored information with a unit type indicator corresponding to the received query response (block 830). In this manner, a positive indication is stored relating to the type of premise 105/110 associated with the work performed. Collectively, the stored information may be referred to as work order status/completion information and it may provide a record of the technician related activities. Processing may then proceed to block 740 of FIG. 7 for subsequent cost to connect metric processing.

Implementations described herein relate to devices, methods, and systems for calculating and presenting multi-customer premises cost to connect calculations and metric information. In one implementation, premises information and equipment may be associated with a unit type indicator that indicates the type of premise associated with the location or equipment. The unit type indicator may be forwarded across multiple inventory, service provisioning, and workflow systems and associated with data collected during the provisioning of service or equipment to particular premises. Workflow (e.g., labor hours) and inventory (e.g., equipment and materials) information associated with the unit type indicator may be compiled to generate accurate and comprehensive cost to connect metric information.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

Further, while series of blocks have been described with respect to FIGS. 7 and 8, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A system for providing multi-customer cost to connect information in a network environment that includes multi-customer premises and single family premises, comprising:
a first system configured to store inventory, equipment, and location information for the network environment,
wherein the location information stored by the first system comprises unit type information indicating whether the location is a multi-customer premise or a single family premise;
a second system configured to provision service installations in the network environment based on information received from the first system, the information received from the first system including at least the unit type information;
a third system configured to receive service installation information from the second system and capturing performance information for the service installation,
wherein the service installation information comprises at least the unit type information; and
a fourth system including processing logic configured to calculate the multi-customer cost to connect information based on information received from the first, second, and third systems,
wherein the information received from the first, second, and third systems includes at least labor information received from the third system and associated with the unit type information indicating multi-customer premises.

2. The system of claim 1,
wherein the first system comprises a facility engineering and accounting system configured to store materials, maintenance, and accounting information relating to equipment and cabling within the environment.

3. The system of claim 1, wherein the second system comprises a service provision system configured to activate and provision service orders in the environment.

4. The system of claim 1, wherein the third system comprises a technician dispatch tool system configured to dispatch work assignments to service technicians.

5. The system of claim 4, wherein the third system comprises:
a plurality of mobile dispatch devices to capture the performance information for the service installation and transmit the captured performance information to the fourth system.

6. The system of claim 5, further comprising:
a fifth system configured to:
receive the captured performance information from the each of the plurality of mobile dispatch devices;
compile the received performance information; and
generate reporting information based on the compiled performance information.

7. The system of claim 6, wherein the fifth system is further configured to transmit at least some of the reporting information to the fourth system.

8. The system of claim 1, wherein the fourth system comprises a capital management system for calculating costs and expenditures associated with provisioning the multi-customer premises and single family premises in the environment.

9. A computing-device implemented method for generating cost to connect information associated with multi-customer premises, comprises:
receiving, from a productivity tracking system, labor time information associated with a number of service installation orders,
wherein the labor time information includes a multi-customer premises indicator;
receiving material information relating to multi-customer premises from an inventory tracking system; and
calculating cost to connect information based on the labor time information and the material information.

10. The method of claim 9, wherein the multi-customer premises indicator is associated with the labor time information based on a response to a technician query during service installation order performance.

11. The method of claim 9, wherein the multi-customer premises indicator is automatically associated with the labor time information based on receipt from an order provisioning system of a unit type indicator associated with the service installation order.

12. The method of claim 11, wherein the unit type indicator is received by the order provisioning system from a facility engineering and accounting system operable to maintain and provide information relating to equipment and cabling within a network environment that includes one or more multi-customer premises.

13. The method of claim 9, wherein the productivity tracking system comprises a plurality of mobile dispatch devices for tracking technician performance of service installation orders.

14. The method of claim 13, wherein the plurality of mobile dispatch devices are configured to periodically transmit the labor time information associated with the number of service installation orders to a capital management system,
wherein the capital management system is configured to automatically calculate the cost to connect information.

15. The method of claim 14, wherein the wherein the plurality of mobile dispatch devices are configured to periodically transmit the labor time information associated with the number of service installation orders to a workforce management system,
wherein the workforce management system is configured to transmit at least some of the labor time information to the capital management system.

16. A computer-readable medium having stored thereon sequences of instructions which, when executed by at least one processor, cause the at least one processor to:
periodically receive, from a workforce management system, labor information associated with a unit type indicator that indicates a type of customer premise;
periodically receive, from an inventory management system, direct materials cost information associated with installations in indicated type of customer premises;
calculate additional materials cost information based on at least the direct materials cost information; and
calculate a cost to connect metric based on the received labor information, direct materials cost information, and the calculated additional materials cost information.

17. The computer-readable medium of claim 16, wherein the unit type indicator is associated with the labor information based on information provided to the workforce management system by an outside plant management system.

18. The computer-readable medium of claim 16, wherein the unit type indicator is associated with the labor information based on a stored response to a technician query received during capture of the labor information.

19. The computer-readable medium of claim 16, wherein the processor to calculate the additional materials costs, comprises calculating the additional materials costs as a percentage of the direct materials costs information.

20. The computer-readable medium of claim 16, wherein the labor information is captured by a plurality of mobile dispatch devices configured to enable technicians to enter and submit information relating to work assignments.
